(19) United States
(12) Patent Application Publication
(10) Pub. No.: US 2025/0161126 A1
(43) Pub. Date: May 22, 2025

(54) APPARATUS AND SYSTEM FOR SUPPORTING AN INDIVIDUAL IN A SEATED POSITION

(71) Applicant: Tarkka Manufacturing Solutions Inc., Calgary (CA)

(72) Inventors: Brett Anthony QUIGLEY, Calgary (CA); Kari Lynne WERNER, Calgary (CA)

(21) Appl. No.: 18/956,765

(22) Filed: Nov. 22, 2024

Related U.S. Application Data
(60) Provisional application No. 63/602,235, filed on Nov. 22, 2023.

(51) Int. Cl. A61G 5/10

(52) U.S. Cl. CPC A61G 5/1045

(57) ABSTRACT

The embodiments of the present disclosure relate to a seat, a back rest and a scaffold that can be used independently or collectively to support a user while in a seated position. The seat and the back rest may each comprise a lattice layer and a base where the lattice structure provides temperature and moisture regulation and the base may provide vibration mitigation properties.

### TECHNICAL FIELD

This disclosure generally relates to supporting individuals in a seated position. In particular, this disclosure relates to an apparatuses, systems and methods for supporting an individual in a seated position.

### BACKGROUND

Wheelchairs are known for supporting and moving individuals while in a seated position. However, if individuals are required to remain in the seated position for extended periods of time, whether in a wheelchair or not, localized and generalized injuries can occur. The occurrence of these injuries may be caused by and/or exacerbated by wheelchair components that are not customized to the specific dimensions and the physical state or capabilities of the user.

Customized components-such as customized seat cushions—are known to provide enhanced fit to a user's dimensions and/or physical state. Customized components typically alter the user's position upon the chair, wheeled or not, and the altered position can adversely change the user's center of gravity upon the chair and, therefore, the users stability may be diminished. Furthermore, such customized components often force the user to have further modifications be made to their wheelchair. For example, if a custom cushion is employed that causes the user's seated position to be higher from the floor—as compared to their seated position without the custom seat-then further modifications are often necessary to allow the user to reach the foot plate. This is because the vertical adjustability of such foot plate connections are often limited in terms of lifting the footplate higher from the floor.

As such, improvements in how individuals are supported in a seated position are warranted.

### SUMMARY

Some embodiments of the present disclosure relate to an apparatus for supporting an individual in a seated position where the apparatus is a seat that comprises a base layer and a cushioned layer.

Some embodiments of the present disclosure relate to an apparatus for supporting an individual in a seated position, wherein the apparatus is a back support that comprises a base layer and a cushioned layer. In some embodiments of the present disclosure, the back support may further comprise a connection assembly that is operatively connectible to a connection plate that is at least partially integral to the back support.

Some embodiments of the present disclosure relate to a seat assembly that comprises a seat and a back rest, wherein each of the seat and the back rest comprise a base layer and a cushioned layer.

Some embodiments of the present disclosure relate to an apparatus for supporting an individual in a seated position, wherein the apparatus is a chair scaffold. The chair scaffold is configured to operatively connect to a pair of rolling wheels and a pair of castors so as to support the scaffold in a rollable fashion. The chair scaffold is configured to be dimensionally modifiable so that one or more physical dimensions of the chair scaffold are changeable so that the user is in an optimized position for self-propulsion.

Some embodiments of the present disclosure relate to a system for supporting an individual in a seated position, wherein the system comprises the seat assembly and the chair scaffold, as described herein.

Some embodiments of the present disclosure relate to a seat that comprises: a lattice that comprises a network of polymer struts that defines multiple cells; and, a base with an upper surface that is operatively coupled with a lower surface of the lattice, wherein the base defines an aperture that in fluid communication with the multiple cells.

Some embodiments of the present disclosure relate to a back rest that comprises: a lattice that comprises a network of polymer struts that defines multiple cells; and, a base with a surface that is operatively coupled with a surface of the lattice, wherein the lattice and the base together define an aperture that extends therethrough; and wherein the lattice and the base together define three hyperbolic parabolic curves.

Some embodiments of the present disclosure relate to a scaffold for supporting a user thereupon is provided with the scaffold comprising: a base that is configured to be operatively connected to one or both of a seat and a back rest and adjustably coupled to a pair of push wheels for changing a wheel base defined by the pair of push wheels, and wherein the base comprises a woven pattern of carbon nanofibers.

### BRIEF DESCRIPTION OF THE DRAWINGS

These and other features of the present disclosure will become more apparent in the following detailed description in which reference is made to the appended drawings.

FIG. 1 shows an isometric view of known wheelchair for supporting an individual in a seated position.

FIG. 2 shows a seat, according to embodiments of the present disclosure, wherein FIG. 2A shows a top-plan view of the seat in use with side rails of a wheelchair, FIG. 2B shows a bottom-plan view of the seat with side rails of a wheelchair, FIG. 2C shows a front-elevation view of the seat with side rails of a wheelchair, FIG. 2D shows a side-elevation view of the seat, FIG. 2E shows an isometric view of a first component of the seat without side rails of a wheelchair, FIG. 2F shows a second component of the seat without side rails of a wheelchair, FIG. 2G shows a closer view of box A from FIG. 2D of struts and cells of a first component of the seat.

FIG. 3 show a back support, according to embodiments of the present disclosure, wherein FIG. 3A shows a rear, isometric view of a first component of the back support, FIG. 3B shows a further isometric view of a second component of the back support, and FIG. 3C shows a top plan view of the first component of the back support, FIG. 3D shows a rear, isometric view of a second component of the back support, and FIG. 3E shows a rear, isometric view of the two components of back support coupled together.

FIG. 4 shows a connector assembly for use with the embodiments of the present disclosure, wherein FIG. 4A shows an isometric view of the connector assembly as assembled, and FIG. 4B shows an isometric, exploded view of the components of the connector assembly.

FIG. 5 shows a chair scaffold according to embodiments of the present disclosure, wherein FIG. 5A shows an isometric view of the scaffold, FIG. 5B shows a side-elevation view of the scaffold, FIG. 5C shows a top-plan view of the scaffold, and FIG. 5D shows a front, elevation view of the scaffold.

FIG. 6 shows a photograph of a system for supporting an individual while seated, according to embodiments of the present disclosure.

FIG. 7 shows an isometric view of a further embodiment of a seat, according to embodiments of the present disclosure.

### DETAILED DESCRIPTION

The embodiments of the present disclosure relate to one or more apparatuses and one or more systems for transporting an individual.

As used herein, the term “about” refers to an approximately +/−10% variation from a given value. It is to be understood that such a variation is always included in any given value provided herein, whether or not it is specifically referred to.

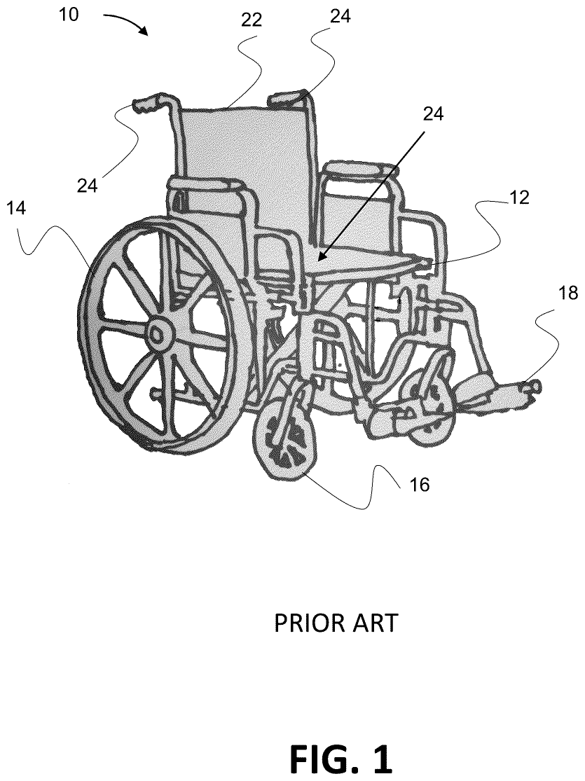

FIG. 1 depicts a known form of a wheelchair 10 and it is shown herein merely to provide but one example of a known system for supporting a person while in a seated position and to provide some context and defined terms that are relevant to this disclosure.

The wheelchair 10 has a frame made up of at least the following components: two seat rails 12 that are opposed to each other and that support a generally planar seat 20, such as a sling seat, therebetween; a pair of push wheels 14; a pair of castor wheels 16; a foot rest 18; and, a back rest 22, such as a sling back rest that is supported between a pair of canes 24. As is well known, a user can be supported upon the generally planar seat 20 and by the back rest 22 with their feet upon the foot rest 18. The user may self-propel by pushing one or both of the push wheels 14 and/or the user may be pushed (or assisted in pushing) the wheelchair 10 by a second person pushing on one or more canes 24.

With this context and these defined terms, embodiments of the present disclosure will now be described by reference to the figures, which show representations of the apparatuses and systems according to the present disclosure.

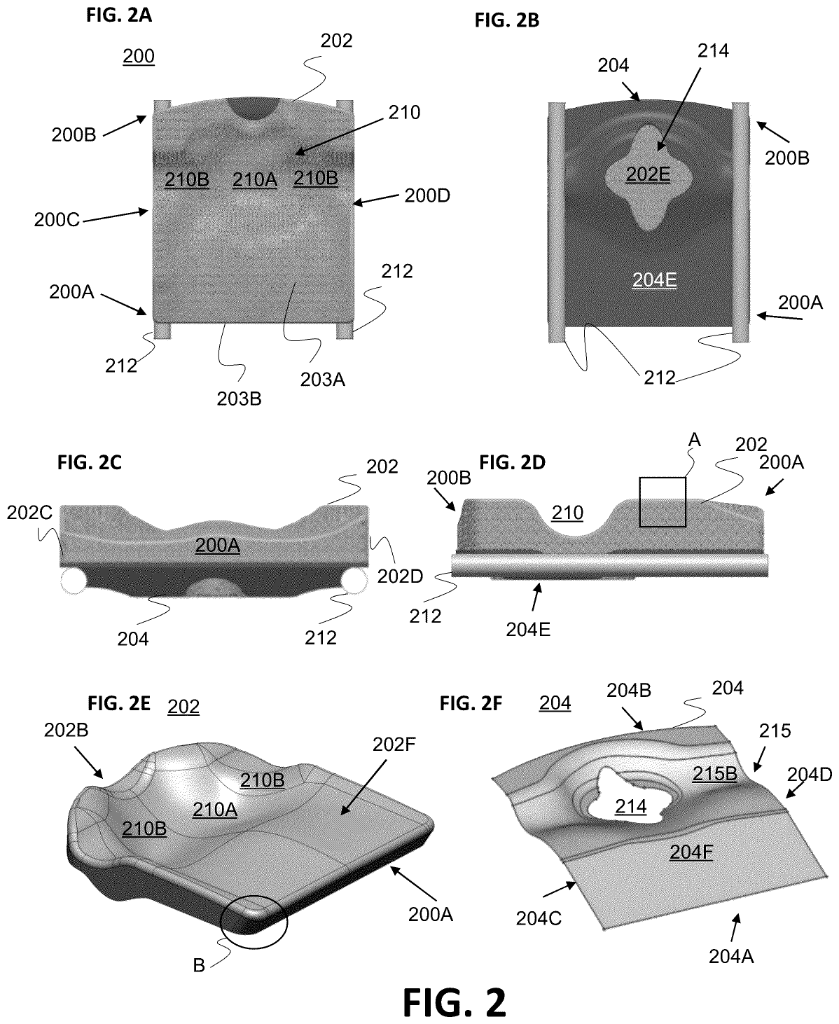

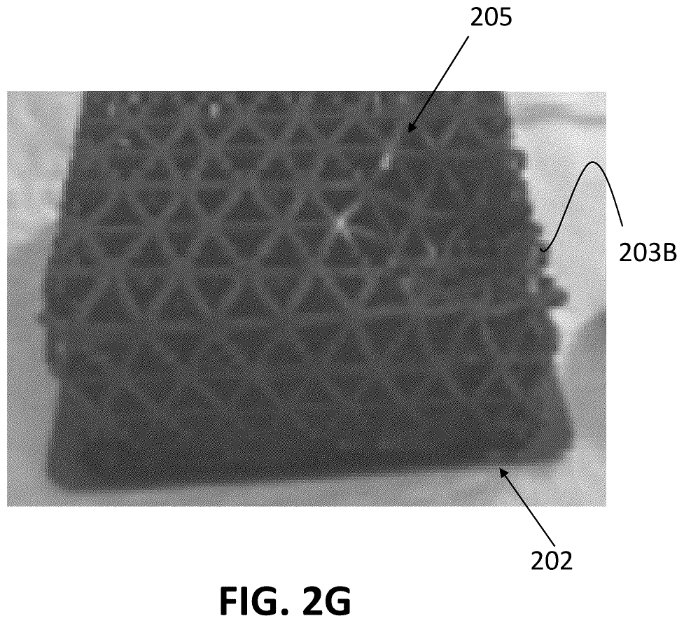

FIG. 2 shows a seat 200 with a front portion 200A, a rear portion 200B, a first side portion 200C and a second side portion 200D. The seat 200 comprises a first component 202 and a second component 204. The first component 202 may also be referred to herein as one or more of a lattice, a cushion or a latticed cushion. The second component 204 may be referred to herein as a base, a seat base or a seat support. The seat 200 is arranged with the lattice 202 positioned upon and operatively connected to an upper surface 204F of the base 204 so that in use, the user (not shown) sits upon and is at least partially supported upon the lattice 202. The base 204 is operatively connectible to a frame of a wheelchair and the base 204 is operatively connectible to a scaffold 500, as described further herein below. Also as described further herein below, the lattice 202 and the base 204 are both shaped so that a lower surface 202E of the lattice 202 abuts and is supported by an upper surface 204F of the lattice 204. The lower surface 202E and the upper surface 204F may have matching shapes so that the lattice 202 can snugly fit upon the base 204.

To assist in orienting the reader, the lattice 202 has a front edge 202A, a back edge 202B, a first side edge 202C, a second side edge 202D, the bottom surface 202E and an upper surface 202F. The user may be at least partially supported upon the upper surface 202F with their posterior towards the back edge 202B and their anterior lower body facing towards the front edge 202C.

As shown in FIG. 2A, FIG. 2D and FIG. 2E, the lattice 202 defines a pelvic well 210 that is a contoured depression in the upper surface 202F and that extends outwardly from and downward from the lower surface 202F. The pelvic well 210 may be positioned more proximal to the rear edge 202B of the lattice 202 than the front edge 202A. The pelvic well 210 is shaped to receive the user's gluteal region therein and to support one or more of the user's pelvis, coccyx, ischial tuberosities (IT) and trochanters. The pelvic well 210 may be shaped or further shaped to minimize areas where there is a higher amount of pressure upon the user by distributing the load of the users weight throughout the pelvic well 210 and other adjacent regions of the lattice 202. In some embodiments of the present disclosure, the pelvic well 210 may comprise a central portion 210A that extends deeper than lateral portions 210B of the pelvic well 210. For example, the central portion 210A may be positioned to receive and support the more central portions of the user's gluteal region, such as their pelvis, ITs and coccyx while the lateral portions 210B may be positioned to receive and support lateral portions of user's gluteal region, such as the user's trochanters. While seated upon the lattice 202, the users gluteal region will be supported in a position that is lower (i.e. closer to the floor upon which the lattice 202 is supported) than the user's femoral and popliteal regions. As such, the user's anterior patellar region may be higher than the user's pelvis. Within the pelvic well 210, the first side edge 202C and the second side edge 202D are shaped to provide lateral support to the user's pelvis.

Without being bound by any particular theory, the pelvic well 210 is configured to redistribute pressure away from high-risk bony prominences of the user, such as the ischial tuberosities (ITs) and the coccyx, by offloading pressure from these areas and directing the associated load toward the proximal thighs and surrounding tissue.

In some embodiments of the present disclosure, the pelvic well 210 is configured to cradle the user's pelvis. As such, the pelvic well 210 defines the depressed central region 210A to accommodate the ITs and coccyx, effectively suspending these bony areas in a “well” of reduced pressure.

The lateral portions 210B of the pelvic well 210 are located laterally of the central portion 210A Located laterally, these lateral portions 210B provide relief by being configured to redistribute pressure outwardly toward the broader and more tissue-rich regions of the proximal thighs and greater trochanters. This allows the seat 200 as a whole to leverage the natural support areas of the user's body that can bear weight more effectively.

The seat assembly is engineered for enhanced anatomical support and optimized pressure distribution. The design incorporates a Double-Intersecting Irregular Freeform Surface Configuration, tailored to conform closely to the user's anatomy while redistributing pressure away from sensitive areas such as the trochanters, coccyx, and ischial tuberosities (ITs).

In some embodiments of the present disclosure, the upper surface of the lattice 202 may also define a first irregular freeform surface that extends laterally along a horizontal axis of the seat 200. This first irregular freeform surface defines the pelvic well 210 to cradle the user's pelvis, thereby stabilizing lateral movement.

The upper surface of the lattice 202 may also define a second irregular freeform surface that extends longitudinally between the front 200A and the rear 200B of the seat 200, which aligns with the user's anterior-posterior axis. The second irregular freeform surface may define one or more rises that are configured to accommodate the user's perineal region and to seamlessly integrate with the pelvic well 210 and extending towards the rear 200B to reduce coccyx contact. As such, the second irregular freeform surface may be configured to enhanced anterior-posterior support of the user, aiding hip alignment and spinal posture.

Furthermore, the upper surface of the lattice 202 may define an intersection of first irregular freeform surface and the second irregular freeform to define a continuous contour that conforms to the anatomical contours of the user's pelvis, thighs, and perineal region.

In general the shape of the seat 200 configures the seat 200 to conform to the user's pelvis and proximal thighs for distributing pressure that arises from sitting over a larger surface area, which reduces peak pressures under the user's ITs and coccyx, which are common sites for pressure ulcers. The seat 200 may be configured to distribute the user's body weight evenly and minimizing high-pressure areas. This weight distribution may protects sensitive regions like the user's coccyx, reducing discomfort and the risk of pressure injuries.

In some embodiments of the present disclosure, the lattice 202 may be made from a polymer and formed by a various known methods that allow for precisely making the desired shape. In some embodiments of the present disclosure, the lattice 202 may be 3 dimensionally (3D) printed in a Voroni form as a monolithic article or a modular article that comprises multiple sections. The Voroni form defines multiple, individual, interior cells 205—which may also be referred to as internal voids, shown in FIG. 2G defined within the lattice 202 by interior struts 203A formed of polymer. Each interior strut 203A may have a cross-sectional diameter of between about 0.5 millimeters (mm) and about 1.5 mm, or between about 0.6 mm and about 1.4 mm, or between about 0.7 mm and about 1.3 mm, or between about 0.8 mm and about 1.2 mm, or between about 0.9 mm and about 1.1 mm.

The perimeter of the lattice 202 may be supported by larger perimeter struts 203B so as to provide additional mechanical strength and stability at the perimeter of the lattice 202 (see FIG. 2G as one example, note the view of FIG. 2G only permits depicting perimeter struts 203B, but it is understood interior struts 203A are positioned in layers with the portion of lattice shown in FIG. 2G). Each perimeter strut 203B may have a cross-sectional diameter of between about 1.5 millimeters (mm) and about 2.0 mm, or between about 1.6 mm and about 1.9 mm, or between about 1.7 mm and about 1.8 mm. The cells 205 may have an average, internal cross-sectional area of between about 6 mm by 6 mm and about 16 mm by about 16 mm with some main cells 205 having an average, internal cross-sectional area of between about 8 mm by about 8 mm and about 14 mm by about 14 mm or about 10 mm by about 10 mm to 12 mm by about 12 mm. As will be appreciated by those skilled in the art, each cell 205 defined within the lattice 202 may have a different average cross-sectional area and, therefore, each cell 205 may define a different volume, as compared to other cells 205 defined by the lattice 202. Furthermore, while FIG. 2F depicts cells as having a triangular or pyramidal shape, those shapes are not the only shapes contemplated. The cells 205 need not define a symmetrical space within the lattice 202. Having cells 205 defined within the struts 203A, 203B of the lattice 202 provides fluid paths for liquids and gases to move within the lattice 202 so that the user is provided measure of both moisture control and temperature control.

In some embodiments of the present disclosure, the struts 203A, 203B of the lattice 202 are made of a thermoplastic polymer, or combinations of two or more thermoplastic polymers, collectively referred to herein as the polymer. The polymer can be selected so that the lattice 202 has desired properties. Non-limiting examples of such desired properties include the polymer being benign to the user's skin, in the case of direct and prolonged contact. A further desired property is that the lattice 202 does not absorb liquids into the struts 203A, 203B and that the lattice 202 is easily washable without the requirement of specialized equipment, such as high pressure washers. A further desired property of the polymer is that it can be shaped and reshaped in the event that the user's dimensions change or the lattice is passed along to a different user. For example, the polymer can be selected so the lattice 202 can be shaped or further shaped upon heating the lattice 202 to a shaping temperature. The shaping temperature is defined as a temperature range that is above the polymer's glass temperature but below the polymer's melting temperature. In some embodiments of the present disclosure, the thermoplastic polymer may be selected to have a shaping temperature of about 100 degrees Celsius (° C.) so that the user's body temperature does not cause the lattice 202 to change shape during use, but also so that special equipment or ovens are not required in order to shape or further shape the lattice 202. A non-exhaustive list of example polymers (or mixes thereof) for making the lattice 202 includes: nylon, acrylonitrile butadiene styrene, acrylic, polybenzimidazole, polycarbonate, polylactic acid, polyoxymethylene, polyether ether ketone, polyether sulfone, polyethylene, polyphenylene oxide, polyphenylene sulfide, polyetherimide, polystyrene, polyvinyl chloride, polyvinylidene fluoride, polytetrafluoroethylene, polypropylene and any combinations thereof.

When manufacturing the lattice 202, physical orientation of the struts 203A, 203B and the cells 205 may provide a further desired property of surface isotrophy to the lattice 202 as a whole, whereby the upper surface 202F has substantially uniform properties, such as mechanical strength, thermal conductivity and/or elasticity in all direction. Without being bound by any particular theory, this surface isotrohpy may ensure that the upper surface 202F behaves consistently regardless of the direction of applied forces or interactions.

The lattice 202 may also define rounded edges—also referred to as rounded-off edges, see the circle in FIG. 2E as an example—to facilitate distributing forces more evenly and reducing stress concentration points that might occur in sharper-edged profiles. Rounded-off edges of the lattice 202 may also provide aerodynamics and fluid dynamic advantages by offering less resistance to airflow and/or or fluid flow through the rounded-off edges.

The seat 200 also comprises the base 204, as shown at least in FIG. 2, wherein the base 204 is configured to be connected with the lattice 202 and the base 204 is operatively connectible to a frame of a wheelchair or a scaffold 500, according to some embodiments of the present disclosure.

As with the lattice 202, the base 204 has a front edge 204A, a back edge 204B, a first side edge 2042C, a second side edge 204D, the bottom surface 204E and an upper surface 204F. As described above, the shape of the base 204 is configured to match the shape of the lattice 202, in that the base 204 is non-planar because it defines a feature 215 that matches the pelvic well 210 of the lattice (see FIG. 2F). As such, the feature 215 may define a lower portion 215A to match the central portion 210A of the pelvic well 210 and the feature 215 may also define two lateral portions 215B, each to match the lateral portions 210B of the pelvic well 210. Additionally, the base 204 defines an aperture 214 that extends between the upper surface 204F and the lower surface 204E. So that when the lattice 202 and the base 204 are connected together, the aperture 214 provides an opening through which fluids, such as liquids and/or gases, may flow in order to enhance the overall temperature and moisture relief properties of the seat 200. While FIG. 2B shows the aperture 214 as being generally cruciform in shape, the person skilled in the art would readily appreciate that other shapes may be equally as effective in providing the temperature and moisture relief properties to the seat 200.

In some embodiments of the present disclosure, the base 204 can be made as a unitary article or a modular article of more than one section. The base 204 can be made of any rigid material that is suitable for supporting the load generated when the user sits upon the lattice 202 and for the loads generated at each point where the base 204 is connected to a wheelchair frame or scaffold 500 of the present disclosure. The base 204 may operatively connect to a frame or scaffold 500 by way of any suitable connector system, including but not limited to: hook-and-loop fasteners, shanks, plugs, threaded connectors and the like so that the seat 200 remains operatively connected to the frame or scaffold 500 while supporting and moving a user in a seated position.

In some embodiments of the present disclosure, the base 204 is made up of woven carbon fibers, which can be compression molded into the desired shape to match the shape of the lower surface 202E of the lattice 202.

In some embodiments of the present disclosure, the base 204 is made up of a composite of woven carbon fibers and a thermoplastic polymer. Without being bound by any particular theory, the use of such a composite may provide the base 204 the desired properties of: a high strength-to-weight ratio, individual moldability, and sustainability through upcycling or recycling. Furthermore, in instances where the base 204 is made as a modular article, different sections of the base 204 may have different physical properties of rigidity, flexibility and/or plasticity. For example, such heterogeneous physical properties may facilitate having lateral portion of the base 204 being more flexible than a central portion to facilitate positioning the base 204 within the non-adjustable frame of a wheelchair.

In some embodiments of the present disclosure, the carbon fibers of the base 204 may be woven in a fashion so as to provide vibration control properties to the base 204 and, hence, the seat 200 as a whole. As but one non-limiting example, the carbon fibers of the base 204—whether as a composite or not—can be woven in a mirrored carbon fiber layup sequence where intersecting carbon fibers at multiple cross sections along a given fiber may reduce the transmission of vibrations along the length of the given fiber. For example, the pattern of weaving the carbon fiber may comprise multiple longitudinal fibers that would normally transmit vibration along their respective lengths, in effect longitudinal fibers may act like a conduit for mechanical energy, which can lead to unwanted noise, structural fatigue, or discomfort. The weave pattern may further comprise intersection points formed by intersecting fibers at strategic points along the length of the longitudinal fibers that intersect the longitudinal fibers at an angle of between 0 and 90 degrees. These cross-sections formed of intersecting fibers interrupts vibrations moving along the longitudinal fibers. As such, each intersection point along a longitudinal fiber may acts as a break or damping point, where the energy of the vibration is dissipated or reduced before it can propagate further down the longitudinal fiber. Furthermore, longitudinal fibers and intersecting fibers maybe layered upon each other establishing multiple intersection points, which creates a complex internal structure that absorbs and disperses vibrational energy. The more intersection points there are, the greater the disruption to the vibration flow, resulting in better damping and vibration isolation.

Intersection points may be defined by the longitudinal fiber having a reference angle of [0° and the intersection fiber may intersect at an angle of 90°, 45°, 30°, 15°, 1° or any angle therebetween.

Without being bound by any particular theory, this weaving pattern of the carbon fibers may enhance structural symmetry and balance which may optimize vibrational energy dissipation. This weaving configuration of carbon fibers extends vibration reduction from the wheelchair frame or scaffold 500 into the base 204, which may minimizes vibration transfer to the user and reducing fatigue that may be experienced during extended use.

When the lattice 202 and the base 204 are connected together, for example by adhesive, suitable connectors or any combination thereof, the seat 200 defines the pelvic well 210 to provide the user with pelvic relief, trochanter relief, and coccyx relief. Furthermore, due to the seat 200 being made at least partially of thermoplastic polymers, the shape of the seat can be modified to strategically position relief areas accommodate to the user's anatomy, physical dimensions and muscular control over their lower body, which may change over time. For example, the seat 200 is configured to be shaped and further shaped to provide relief areas that optimize pressure distribution and to minimize high-pressure areas. Further, the lattice 202 may facilitate managing microclimates by enhancing airflow and moisture control while delivering dynamic pressure relief and load distribution.

Because the bottom of the pelvic well 210 and the feature 215 both extend down and below the side portions 200C, 200B of the seat 200, the user can be positioned with a portion of their gluteal region below the side bars of the wheel chair frame or the side bars of a scaffold 500. This position of the user may enhance the user's stability by lowering their center of gravity relative to the side bars, while occupying a seated position, whether moving or not.

Because the lattice 202 can be made from 3D printing and the base 204 can be made from different materials using a less expensive process, such as carbon fiber weaving and pressure molding, the overall cost of manufacturing the seat 200 can be considerably less and more time efficient than manufacturing the entire seat from 3D printing. Furthermore, using thermoplastic polymers within the seat 200 enhance the recyclability of the materials used therein.

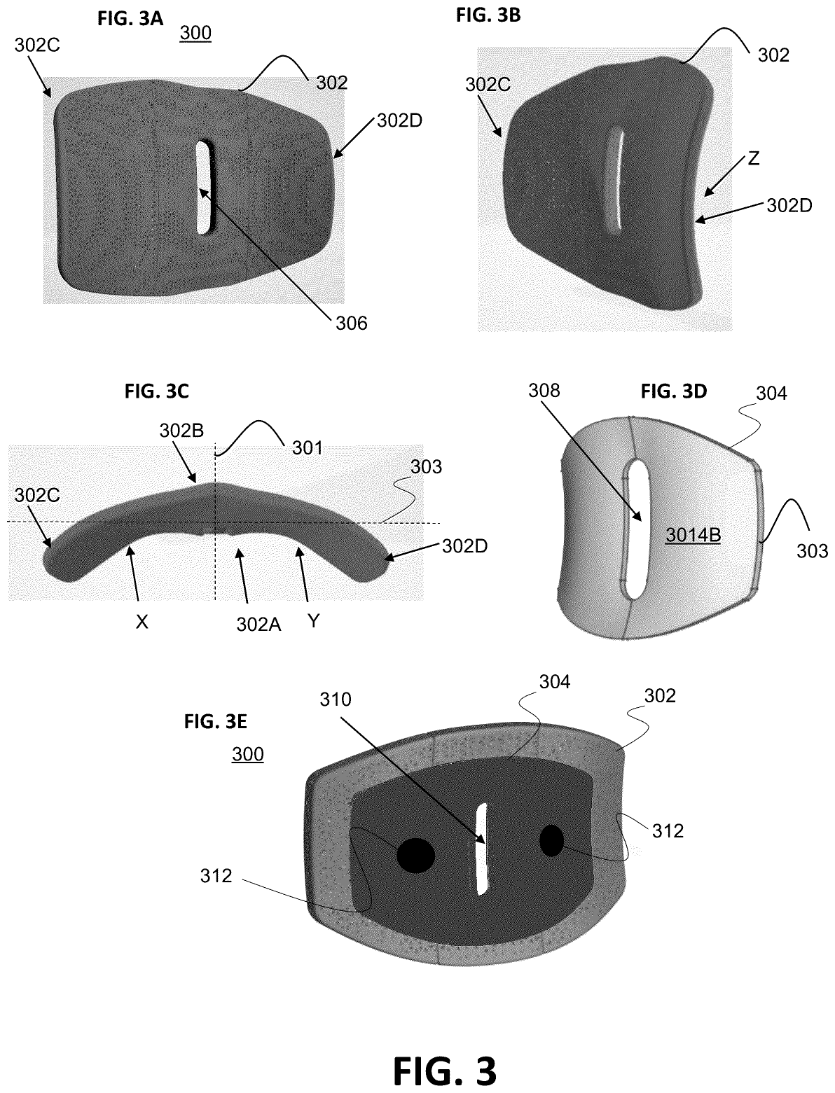

FIG. 3 shows a back rest 300 that can be used to at least partially support a user's body weight while they are in the seated position. The back rest 202 is defined by multiple quadratic surfaces, such as a front surface 302A, a back surface 302B, a first side edge 302C and a second side edge 302D. As shown in FIG. 3C, the back rest 300 may define at least two symmetrical axes. The term symmetrical axis is used herein to the sections of the back rest 300 that are divided on each side of a given axis may be mirror images of each other. A first axis (depicted by line 301) extends between the front surface 302A and the back surface 302B, generally about a mid-line of the back rest 300. The back rest 300 may also define a second axis (depicted by line 303) that extends between side edges 302C, 302D. Generally speaking, the first axis 301 may be perpendicular to the second axis.

The back rest 300 has a triple, hyperbolic parabolic shape that comprises three distinct hyperbolic paraboloid shapes, each of which is defined by two sets of parallel lines and each of these sets are not parallel to the other. The geometric complexity of this triple, hyperbolic parabolic shape provides multi-dimensional support across the users thoracic, lumbar, and sacral regions, optimizing strength-to-weight efficiency while maintaining flexibility and stability.

The back rest 300 defines a first hyperbolic parabolic shape X between the first axis 301 and the first edge 302C, a second hyperbolic parabolic shape Y between the first axis 301 and the second edge 302D and a third hyperbolic parabolic shape Z that extends along the second axis 303 between the first and second edges 302C, 302D. The first hyperbolic parabolic shape X is configured to provide the user lateral support towards the first side 300C of the backrest 300 by conforming to the natural curvature of one side of the user's thoracic and lumbar regions. The second hyperbolic parabolic shape Y is configured to provide the user lateral support towards the second side 300D of the backrest 300 by conforming to the natural curvature of the other side of the user's thoracic and lumbar regions. The third hyperbolic parabolic shape Z is configured to supports the posterior aspects of the user's thoracic, lumbar, and sacral regions, promoting proper spinal alignment along the spine's length.

In some embodiments of the present disclosure, the back rest 300 may define a spinal relief window 306 that is configured to enhance user comfort and adaptability. The spinal relief window may be positioned along the first axis 301 and it may alleviate direct pressure on the user's spinal column, which without being bound by any particular theory may create a dedicated relief zone for users with conditions such as scoliosis, kyphosis, or other spinal deformities. In particular, the spinal relief window 306 may specifically mitigate pressure on the user's spine that could arise from the third hyperbolic paraboloid Z, particularly when users lean forward (anteriorly) and curve their back into the backrest 300.

Similar to the seat 200, in some embodiments of the present disclosure, the back rest 300 may comprise a lattice portion 302 and a back rest base 304. The lattice portion 302 can be made of the same materials as the lattice 202 and manufactured using 3D printing of the polymer, as described herein above. A non-exhaustive list of example polymers (or mixes thereof) for making the lattice portion 302 includes: nylon, acrylonitrile butadiene styrene, acrylic, polybenzimidazole, polycarbonate, polylactic acid, polyoxymethylene, polyether ether ketone, polyether sulfone, polyethylene, polyphenylene oxide, polyphenylene sulfide, polyetherimide, polystyrene, polyvinyl chloride, polyvinylidene fluoride, polytetrafluoroethylene, polypropylene and any combinations thereof. The lattice 202 and the lattice portion 302 may be made with the same polymer or not.

As such, the lattice portion 302 may comprise the same structural components as the lattice 202, including peripheral struts and interior struts that together establish a structural network of polymer material that defines multiple cells. Similar to the lattice 202, the lattice portion 302 may be shaped and further shaped to provide relief areas where pressure upon the user may be localized. Furthermore, the lattice portion 302 may provide further temperature and moisture regulation by permitting fluid circulation through the multiple cells.

As a component of the back rest, the back rest base 304 has a matching shape to the back surface 302B and it can be made of the same materials as the base 204 described herein above. As such, the back rest base 304 may be a monolithic article or a modular article that is formed of suitable rigid materials. Furthermore, in instances where the back rest base 304 is made as a modular article, different sections of the back rest base 304 may have different physical properties of rigidity, flexibility and/or plasticity. For example, such heterogeneous physical properties may facilitate having lateral portion of the back rest base 204 being more flexible than a central portion so that it is possible to bend a lateral portion of the back rest away from the user's back to facilitate placing a support article, such as a sling, about the user to assist in lifting the user.

In some embodiments of the present disclosure, the back rest 304 may comprise carbon fibers that are woven in a fashion so as to provide vibration control properties to the back rest base 304 and, hence, the back rest 300 as a whole. As but one non-limiting example, the carbon fibers of the back rest base 304—whether as a composite or not—can be woven in a mirrored carbon fiber layup sequence where intersecting carbon fibers at multiple cross sections along a given fiber may reduce the transmission of vibrations along the length of the given fiber. For example, the pattern of weaving the carbon fiber may comprise multiple longitudinal fibers that would normally transmit vibration along their respective lengths, in effect longitudinal fibers may act like a conduit for mechanical energy, which can lead to unwanted noise, structural fatigue, or discomfort. The weave pattern may further comprise intersection points formed by intersecting fibers at strategic points along the length of the longitudinal fibers that intersect the longitudinal fibers at an angle of between 0 and 90 degrees. These cross-sections formed of intersecting fibers interrupts vibrations moving along the longitudinal fibers. As such, each intersection point along a longitudinal fiber may acts as a break or damping point, where the energy of the vibration is dissipated or reduced before it can propagate further down the longitudinal fiber. Furthermore, longitudinal fibers and intersecting fibers maybe layered upon each other establishing multiple intersection points, which creates a complex internal structure that absorbs and disperses vibrational energy. The more intersection points there are, the greater the disruption to the vibration flow, resulting in better damping and vibration isolation.

Intersection points may be defined by the longitudinal fiber having a reference angle of 0° and the intersection fiber may intersect at an angle of 90°, 45°, 30°, 15°, 1° or any angle therebetween.

Without being bound by any particular theory, this weaving pattern of the carbon fibers may enhance structural symmetry and balance which may optimize vibrational energy dissipation. This weaving configuration of carbon fibers extends vibration reduction from the wheelchair frame or scaffold 500 into the back rest base 304, which may minimizes vibration transfer to the user and reducing fatigue that may be experienced during extended use.

In some embodiments of the present disclosure, the back rest base 304 may have one or more connection points 312 where a connection member can be operatively coupled to the back rest base 304 so as to connect the back rest to the frame of a wheelchair or to a scaffold, according to embodiments of the present disclosure. In some embodiments of the present disclosure, a portion of the connection member may be incorporated into the material of the back rest base 304.

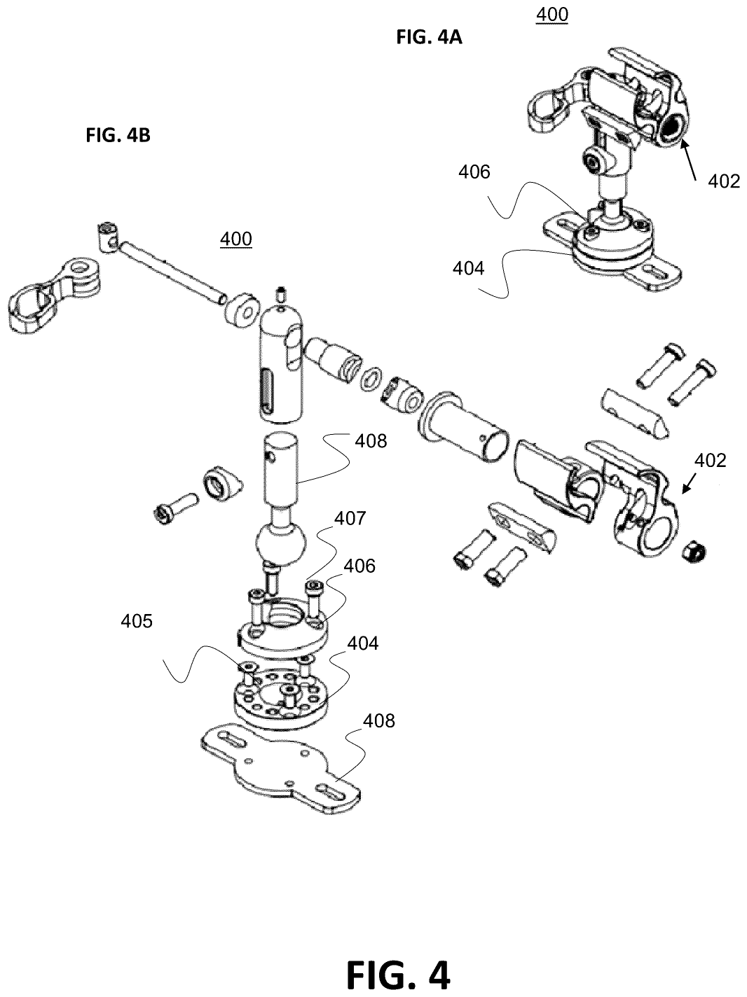

For example, the connection member may be a 5-axis pivotal connector 400, as shown in FIG. 4. The connector 400 comprises a connector plate 404 that can be woven into the carbon fiber of the back rest base 304—or otherwise incorporated into the materials that are used to make the back rest base 304 so the connector plate 404 is fixed into the back rest base 304. For example, the connector plate 404 may define a flat socket that can receive a rounded end of a stem 408. The connector plate 404 is configured to releasably receive one or more connectors 407 that also extend through a rounded socket plate 406 that is positioned opposite to the connector plate 404. The rounded socket plate 406 may define a lateral aperture through which the stem 408 can be positioned within the plate 404 and a central aperture that retains the stem 408 in place when the connectors 407 are employed to connect the plate 404 with the plate 406. When connected, the stem articulate in 5 axes, including tilt (anterior or posterior) and rotation. This adjustability allows for tailored support to meet individual anatomical needs, accommodating postural deformities and deviations from neutral positioning, while securing a flat plate (i.e. the connector plate 404) within the curved surface of the back rest base 304.

As shown in FIG. 4, the connection member 400 may comprise various other components including a clamp 402 that is configured to be secured to a portion of a wheelchair frame or a scaffold 500.

Unlike known planar seating systems, the seat 200 and the back rest 300, either used together or separately, distributes a user's body weight into a contoured shape, supporting the user's body against gravity to promote functional posture and reduce pressure on the user's pelvis and spine, as the case may be. The integrated adjustable lumbar support provided by the back rest 300 may maximize contact with the user's back, while maintaining a minimally invasive profile that optimizes postural alignment, enhances comfort, and minimizes the risk of pressure-related injuries.

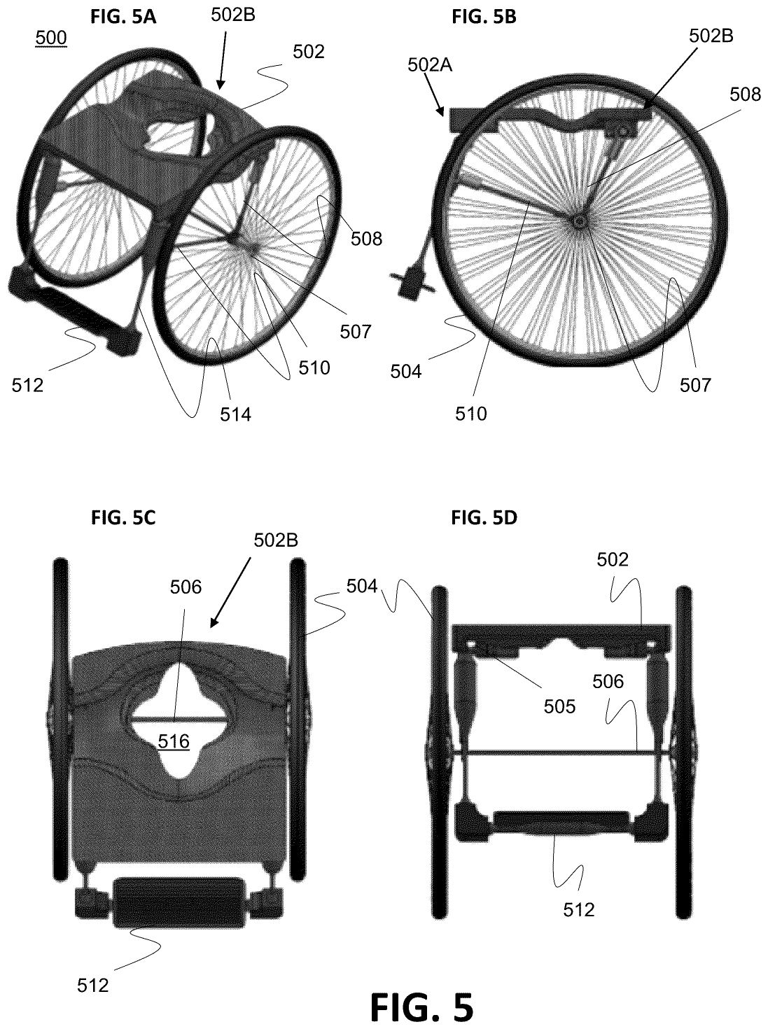

Some embodiments of the present disclosure relate to the scaffold 500, as shown in FIG. 5. The scaffold 500 comprises a seat base 502, such as the base 202 described herein above, side rails, struts and roller wheels. The seat base 502 may be supported upon two opposed side rails 505 so that a feature, such as the feature 215 allows at least a portion of the user's gluteal region to be positioned below the side rails 505. A rear support strut 508 may also be fixed to each side rail 505 and extend downward from a rear 502B of the seat base 502 to a central hub 507 of each of two push wheels 504. A front strut 510 may extend from the central hub 507 to connect to the side rail 507 proximal a front 502A of the seat base 502. The scaffold 500 may further comprise two front support arms 514 that both extend from the front 502A of the seat base 502 with a foot plate 512 connected to the distal end of each support arm 514. Castor wheels (not shown) may be operatively connected to the front support arms 514 and/or the foot plate 512.

The scaffold further comprises a central connector 506 that extends between the hubs 507 of each push wheel 504. Each roller wheel 504 is independently rollable, as such each wheel 504 is operatively coupled to each respective hub 507 and the central connector 506 is not required to act as an axle. As shown in FIG. 5C, the base defines an aperture 516, which is positioned above the central connector 506.

In some embodiments of the present disclosure, each point where a component of the scaffold 500 connects to another component, such connection points are adjustable so as to allow the dimensions of the scaffold to be changed to accommodate the anatomy of the user. For example, the length of the central connector 506 may be adjusted so as to change the distance between an inner surface of each wheel 504 and each respective side rail 505. Furthermore, the distance between the base 502 and the floor may also be adjusted—which may be referred to as the floor height—so that when the dimensions of the scaffold 500 are suitably adjusted to the anatomy and dimensions of the user, the user may in a seated position that is an optimal position for self propulsion. For clarity, an optimal position for self-propulsion is used to refer to a position where the users arms are able to hang straight down without placing strain on the users shoulders, which can be caused by the user having to extend their shoulders laterally in order to reach the push wheels 504 and with a reduced need to bend anteriorly to reach down to the push wheels 504.

In some embodiments of the present disclosure, various of the scaffold 500 components are constructed of the same materials as the base 204 and the back rest base 304. For example, portions of the scaffold 500 can be made of carbon fiber (either alone or as a composite) in a woven pattern that provides vibration mitigation, as described herein.

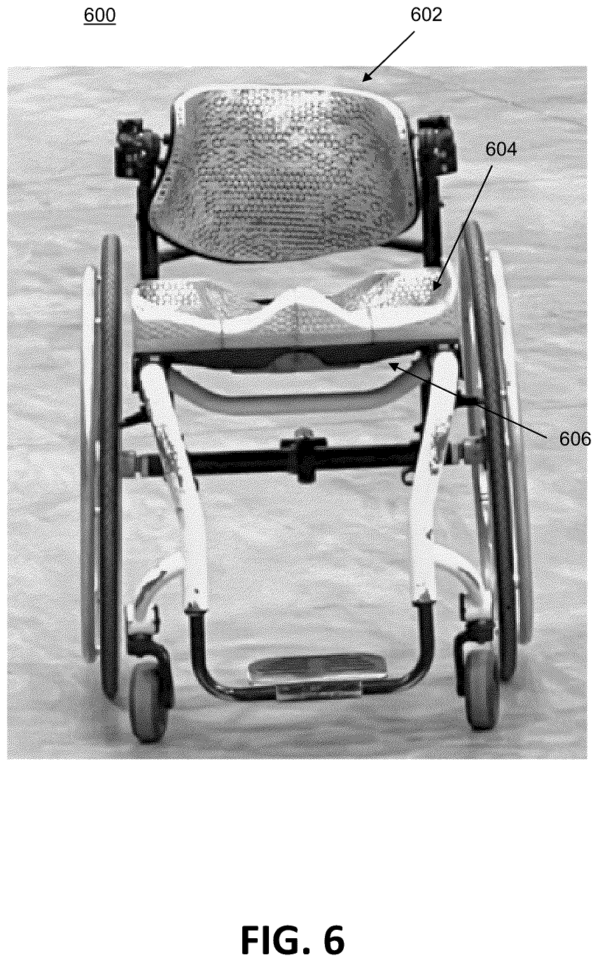

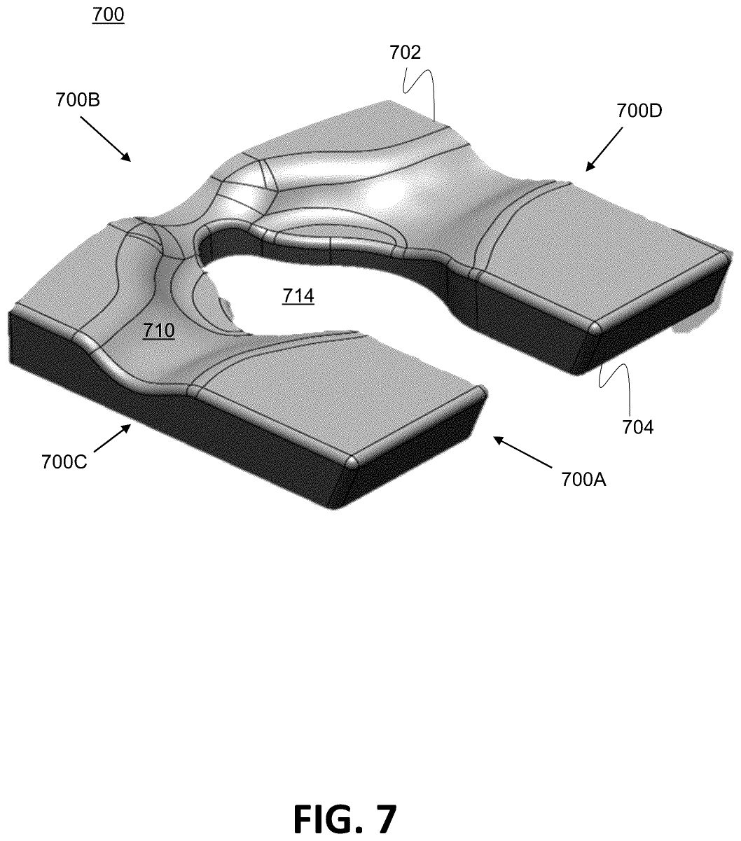

Some embodiments of the present disclosure relate to a system 600 for supporting and moving a user who is in a seated position (see FIG. 6). The system 600 may comprise a back rest 602, a seat 604 and a scaffold 606. In some embodiments of the present disclosure, the back rest 602 is the back rest 300 described herein above. In some embodiments of the present disclosure, the seat 604 is the seat 200 described herein above. In some embodiments of the present disclosure, the scaffold 606 is the scaffold 606 described herein above. As such, the system 600 may comprise the scaffold 500 and the back rest 300 with or without the seat 200 and the system 600 may comprise the scaffold 500 with the seat 200 with out the back rest 300.

Other embodiments of the present disclosure relate to a seat 700 that has a front 700A, a rear 700B, a first side 700C and a second side 700D. The seat 700 comprises an upper lattice section 702 and a lower base 704. The lattice section 702 lower base 704 may be the same as the lattice 202 and the base 204, respectively, as described herein above. For example, the lattice section 702 defines a pelvic well 710 similar to the pelvic well 210 described herein above. At least one difference between the seat 700 and the seat 200 is that the seat 700 defines an aperture 714 that extends through both of the lattice section 702 and the lower base 704 and the aperture extends from a midline point of the front 700A towards the pelvic well 710. Without being bound by any particular theory, the seat 700 may be suitable for positioning upon a commode.

Without being bound by any particular theory, the pelvic well 210—including the central portion 210A and the lateral portions 210B serve as precise landmark mounting surfaces, enabling seamless integration with the latticed scaffolding of the wheelchair frame. This ensures a secure and precise fit, creating a unified structural system. The interdependence of the seat base and scaffolding enhances biomechanical support and structural integrity for the complete wheelchair assembly. For example, lattice 202 provides different zones of support that further enhances pressure redistribution from the particularly sensitive areas of the user's ITs and coccyx. The lattice 202 is configured to flex and is adaptable, ensuring that pressure is offloaded from sensitive areas and evenly distributed to the user's proximal thighs and gluteal regions.

Without being bound by any particular theory, the lattice 202 may be configured to enhance airflow and, therefore, reduce heat and moisture buildup. The enhanced airflow may facilitate preserving the user's skin integrity and dramatically lowering the risk of ulcers and/or infection during extended periods of sitting.

Without being bound by any particular theory, the seat base 204 that is at least partially composed of woven carbon fiber may be shaped to accommodate the user's pelvis in a seated position and to stabilize the user's pelvis when combined with the lattice 202, as described herein above. Additionally, some embodiments of the present disclosure relate to establishing connection points that align with the formed shape of the seat 200 with the scaffold for attaching push wheels and castor wheels to the base to effectively turn the seat base into a wheelchair either at point of order or as an add on kit that can be attached.

Without being bound by any particular theory, the precise shape of the seat 200 and the back rest 300 can each be further shaped (or contoured) “bedside” by applying heat raise the temperature of the respective thermoplastic polymers to accommodate specialized shapes or opening and closing of the shape to accommodate any further dimensional changes that may be needed or desired to better support the user in the seated position.

Without being bound by any particular theory, the scaffold 500 may serve as a static mounting platform for the wheelchair's primary load-bearing elements, including the rear push wheels and the front caster assemblies. The precise alignment and secure attachment of the scaffold 500 to the seat 200 creates a unified structural system that transforms the seat base into a fully functional wheelchair chassis.

The individual custom width of the wheelbase, achieved through the variable positioning of the push wheels with respect to the scaffold 500 may minimize lateral displacement and improve biomechanical efficiency of self-propulsion by the user. This arrangement may reduce the strain on the user's shoulders and decreases the risk of repetitive stress/stain injuries, such as rotator cuff injuries, associated with prolonged wheelchair use.

Without being bound by any particular theory, the modular design of the seat 200, the back rest 300 and the scaffold 400 enables the system 600 to be implemented at two stages: it can be ordered concurrently with the initial seating provision for a fully integrated solution (i.e. with the seat, back rest and scaffold) or acquired as an add-on kit post-seating provision. This dual-phase availability maximizes flexibility in accommodating the evolving needs of the user.

Without being bound any particular theory, the back rest 300 described herein may also be useful for supporting at least part of a user's body weight while they are being supported by an exoskeleton in a position other than a seated position.

Without being bound by any particular theory, the embodiments of the present disclosure may also be described as aspects of the apparatuses and systems described herein. For example, in a first aspect a seat is provided that comprises: a lattice that comprises a network of polymer struts that defines multiple cells; and, a base with an upper surface that is operatively coupled with a lower surface of the lattice, wherein the base defines an aperture that in fluid communication with the multiple cells.

In a second aspect, the base of the seat of the first aspect is connectible to a side rail and wherein the lattice and the base both define a pelvic well that is configured to receive a portion of a user and to position the received portion below the side rail when connected to the base.

In a third aspect, the base of the seat of the first aspect and/or the second aspect comprises a woven arrangement of longitudinal carbon fibers and intersecting carbon fibers, wherein the intersecting carbon fibers are configured to mute or dissipate vibration that propagates along the longitudinal carbon fibers.

In a fourth aspect, the intersecting carbon fibers of the seat of the third aspect intersect the longitudinal carbon fibers at an angle between about 1° and about 90°.

In a fifth aspect, the network of polymer struts of the first, second, third and/or fourth aspect comprises a plurality of peripheral polymer struts and a plurality of interior polymer struts, wherein each of the plurality of interior polymer struts have a smaller cross-section diameter than a cross-sectional diameter of each of the plurality of peripheral struts.

In a sixth aspect, the network of polymer struts of first, second, third, fourth and/or fifth aspect comprises a thermoplastic polymer.

In a seventh aspect, the base of the third aspect further comprises a thermoplastic polymer.

In an eighth aspect, a back rest is provided that comprises: a lattice that comprises a network of polymer struts that defines multiple cells; and, a base with a surface that is operatively coupled with a surface of the lattice, wherein the lattice and the base together define an aperture that extends therethrough; and wherein the lattice and the base together define three hyperbolic parabolic curves.

In a ninth aspect, the base of the eighth aspect comprises a woven arrangement of longitudinal carbon fibers and intersecting carbon fibers, wherein the intersecting carbon fibers are configured to dissipate vibration that propagate along the longitudinal carbon fibers.

In a tenth aspect, the network of polymer struts of the eighth aspect and/or the ninth aspect comprises a thermoplastic polymer.

In an eleventh aspect, the base of the eighth aspect, the ninth aspect and/or the tenth aspect comprises a thermoplastic polymer.

In a twelfth aspect, the back rest of the eighth aspect, the ninth aspect and/or the eleventh aspect comprising a connector plate that is incorporated into a surface of the base.

In a thirteenth aspect, the back rest of the of the eighth aspect, the ninth aspect, the eleventh aspect and/or the twelfth aspect further comprising a connection assembly that is pivotably connected to the connector plate.

In a fourteenth aspect, a scaffold for supporting a user thereupon is provided with the scaffold comprising: a base that is configured to be operatively connected to one or both of a seat and a back rest and adjustably coupled to a pair of push wheels for changing a wheel base defined by the pair of push wheels, and wherein the base comprises a woven pattern of carbon nanofibers.

In a fifteenth aspect, a system for supporting a user while in a seated position is provided with the system comprising: the scaffold of the fourteenth aspect; and one or both of the seat of any one of aspects 1 through 7 and the back rest of any one of the aspects 8 through 13.

1. A seat comprising:
(a) a lattice that comprises a network of polymer struts that defines multiple cells; and,
(b) a base with an upper surface that is operatively coupled with a lower surface of the lattice,
(c) wherein the base defines an aperture that in fluid communication with the multiple cells.

2. The seat of claim 1, wherein the base is connectible to a side rail and wherein the lattice and the base both define a pelvic well that is configured to receive a portion of a user and to position the received portion below the side rail when connected to the base.

3. The seat of claim 1, wherein the base comprises a woven arrangement of longitudinal carbon fibers and intersecting carbon fibers, wherein the intersecting carbon fibers are configured to mute or dissipate vibration that propagates along the longitudinal carbon fibers.

4. The seat of claim 3, wherein the intersecting carbon fibers intersect the longitudinal carbon fibers at an angle between about 1° and about 90°.

5. The seat of claim 1, wherein the network of polymer struts comprises a plurality of peripheral polymer struts and a plurality of interior polymer struts, wherein each of the plurality of interior polymer struts have a smaller cross-section diameter than a cross-sectional diameter of each of the plurality of peripheral struts.

6. The seat of claim 1, wherein the network of polymer struts comprises a thermoplastic polymer.

7. The seat of claim 3, wherein the base further comprises a thermoplastic polymer.

8. A back rest comprising:
(a) a lattice that comprises a network of polymer struts that defines multiple cells; and,
(b) a base with a surface that is operatively coupled with a surface of the lattice,
wherein the lattice and the base together define an aperture that extends therethrough; and
wherein the lattice and the base together define three hyperbolic parabolic curves.

9. The back rest of claim 8, wherein the base comprises a woven arrangement of longitudinal carbon fibers and intersecting carbon fibers, wherein the intersecting carbon fibers are configured to dissipate vibration that propagate along the longitudinal carbon fibers.

10. The back rest of claim 8, wherein the network of polymer struts comprises a thermoplastic polymer.

11. The back rest of claim 9, wherein the base further comprises a thermoplastic polymer.

12. The back rest of claim 8, further comprising a connector plate that is incorporated into a surface of the base.

13. The back rest of claim 12, further comprising a connection assembly that is pivotably connected to the connector plate.

14. A scaffold for supporting a user thereupon, the scaffold comprising:
(a) a base that is configured to be operatively connected to one or both of a seat and a back rest and adjustably coupled to coupled to a pair of push wheels for changing a wheel base defined by the pair of push wheels, and
wherein the base comprises a woven pattern of carbon nanofibers.

15. A system for supporting a user while in a seated position, the system comprising:
(a) the scaffold of claim 14; and/or
(b) and one or more the seat of claim 1 and the back rest of claim 8.

16. The system of claim 15, comprising the seat of claim 1, wherein the base is connectible to a side rail and wherein the lattice and the base both define a pelvic well that is configured to receive a portion of a user and to position the received portion below the side rail when connected to the base.

17. The system of claim 15, comprising the back rest of claim 8, wherein the back rest base comprises a woven arrangement of longitudinal carbon fibers and intersecting carbon fibers, wherein the intersecting carbon fibers are configured to dissipate vibration that propagate along the longitudinal carbon fibers.
